(19) United States
(12) Patent Application Publication
(10) Pub. No.: US 2009/0135692 A1
(43) Pub. Date: May 28, 2009

(54) APPARATUS AND METHOD FOR DETERMINING WRITE STRATEGY, AND APPARATUS AND METHOD FOR RECORDING DATA

(75) Inventors: WOOK-YEON HWANG, Seoul (KR); Kyung-geun Lee, Seongnam-si (KR); In-oh Hwang, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/038,973

(22) Filed: Feb. 28, 2008

(30) Foreign Application Priority Data
Mar. 26, 2007 (KR) 2007-29369

(51) Int. Cl. G11B 7/00

(52) U.S. Cl. 369/47.53; G9B/7

(57) ABSTRACT

An apparatus and method for determining an optimal write strategy when recording data onto an optical disk, and an apparatus and method for recording data, the method of determining a write strategy including: recording test data for each size of marks and spaces based on a plurality of write strategies; reproducing the recorded test data; measuring jitter values of the reproduced test data based on the plurality of write strategies; and determining an optimal write strategy according to the measured jitter values.

### CROSS-REFERENCE TO RELATED APPLICATION

This application claims the benefit of Korean Application No. 2007-29369, filed Mar. 26, 2007 in the Korean Intellectual Property Office, the disclosure of which is incorporated herein by reference.

### BACKGROUND OF THE INVENTION

1. Field of the Invention

Aspects of the present invention relate to an apparatus and method for determining an optimal write strategy, and an apparatus and method for recording data when recording data onto an optical disk.

2. Description of the Related Art

As storage capacities of conventional CD-ROMs reach an upper limit, digital versatile discs (DVDs) have been developed as new storage media. The DVD is not substantially different from a CD in an operating mechanism. That is, in both the CD and the DVD, a difference in quantity of light is recognized to represent binary data such as 0's or 1's. However, in -DVDs, a storage width of a track of the data is smaller as compared to the CDs.

CDs and DVDs can be classified into three types including a read-only memory (ROM) type, a write once read many (WORM) type, and a re-recordable type.

An optical recording and reproducing apparatus to record and reproduce data in an optical disk (such as a CD or DVD) records information onto the optical disk by irradiating a light beam having a high energy that changes physical properties of an information recording layer. Furthermore, the optical recording and/or reproducing apparatus reproduces information from the optical disk by using a light beam having a low energy that does not change the physical properties of the information recording layer. That is, when recording data, the information is generally recorded by forming pits on the optical disk by driving a laser diode (LD) having a high recording power. Here, a procedure of forming pits on a disk is referred to as a write strategy.

Since the laser beam is incident on a surface of the disc opposite to a reflection surface, the pits look like protrusions from the laser incident side. The width of the pits range from 0.4 urn to 0.6 um. The length of the pits and the interval between neighboring pits depend on the type of the optical disk. In the case of CDs, the interval ranges from 3T to 11T, where T is a length of a clock pulse (for example, 2T is the length of two clock pulses and 9T is the length of nine clock pulses). In the case of DVDs, the interval ranges from 3T to 14T. In the case of a Blu-ray Disc (BD), the interval ranges from 2T to 9T

The write strategy indicates a laser focusing time and a magnitude of power of a laser. The reproduction quality of the optical disk onto which data is recorded depends on the laser focusing time and the magnitude of the power of the laser. When the same write strategy is applied to various optical disks or recording and reproducing apparatuses, signal quality may deteriorate. Accordingly, in order to obtain a high reproduction quality, a suitable write strategy must be determined.

### SUMMARY OF THE INVENTION

Aspects of the present invention provide an apparatus and method to determine an optimal write strategy based on a disk or recording and reproducing apparatus and to record data by using the determined write strategy.

According to an aspect of the present invention, there is provided a method of determining a write strategy, the method including: recording test data for each size of marks and spaces based on a plurality of write strategies; reproducing the recorded test data; measuring jitter values of the reproduced test data for each of the plurality of write strategies; and determining an optimal write strategy according to the measured jitter values.

The determining of the optimal write strategy by using the measured jitter value may include: constructing a jitter matrix for each size of the marks and the spaces by using the measured jitter values; and determining a write strategy for which an absolute value of a measured jitter value is minimized from the jitter matrix.

The plurality of write strategies may have various laser focusing time lengths.

In the constructing of the jitter matrix for each size of the marks and the spaces by using the measured jitter values, positive and negative matrices may be separately constructed by using the measured jitter values.

The determining of the write strategy in which the absolute value of a measured jitter value is minimized from the jitter matrix may include: obtaining a function of jitter values based on the write strategies from the positive and negative jitter matrices; and determining a write strategy in which a jitter value is zero from the function of jitter values based on the write strategies.

The determining of the write strategy in which the jitter value is zero from the function of jitter values based on the write strategies may include: transforming the function of jitter values based on the write strategies into a first order approximation formula; and determining the write strategy in which the jitter value is zero from the transformed first order approximation formula.

In the constructing of the jitter matrix for each size of the marks and the spaces by using the measured jitter values, positive and negative matrices may be separately constructed by using the measured jitter values, and the constructed jitter matrices may include information on frequency of jitter occurrences for each size of the marks and the spaces.

The determining of the write strategy in which the absolute value of the measured jitter value is minimized from the jitter matrix may include: obtaining a function of frequency of jitter occurrences based on the write strategies from the positive and negative matrices; and determining a write strategy in which a frequency of jitter occurrences is zero from the function of frequency of jitter occurrences based on the write strategies.

The determining of the write strategy in which the frequency of jitter occurrences is zero from the function of frequency of jitter occurrences based on the write strategies may include: transforming the function of frequency of jitter occurrences based on the write strategies into a first order approximation formula; and determining a write strategy in which the frequency of jitter occurrences is zero from the transformed first order approximation formula.

According to another aspect of the present invention, there is provided an apparatus for determining a write strategy, the apparatus including: a recording and reading unit to record test data for each size of marks and spaces based on a plurality of write strategies and to reproduce the recorded test data; and a control unit to measure jitter values of the reproduced test data based on the plurality of write strategies and to determine a write strategy of an optical disk by using the measured jitter values.

The control unit may include: a measurement unit to measure the jitter values of the reproduced test data based on the plurality of write strategies; a matrix construction unit to construct a jitter matrix for each size of the marks and the spaces by the measured jitter values; and a determination unit to determine a write strategy in which an absolute value of a measured jitter value is minimized from the jitter matrix.

The plurality of write strategies may have various laser focusing time lengths.

The matrix construction unit may separately construct positive and negative matrices by using the measured jitter values.

The determination unit may obtain a function of jitter values based on the write strategies from the positive and negative jitter matrices and determine a write strategy in which a jitter value is zero from the function of jitter values.

The determination unit may further include a transformation unit to transform the function of jitter values based on the write strategies into a first order approximation formula, and the determination unit may determine a write strategy in which the jitter value is zero from the transformed first order approximation formula.

The matrix construction unit may separately construct positive and negative matrices by using the measured jitter value, and the constructed jitter matrices may include information on frequency of jitter occurrences for each size of the marks and the spaces.

The determination unit may obtain a function of frequency of jitter occurrences based on the write strategies from the positive and negative matrices and determine a write strategy in which a frequency of jitter occurrences is zero from the function of frequency of jitter occurrences based on the write strategies.

The determination unit may further include a transformation unit to transform the function of frequency of jitter occurrences based on the write strategies into a first order approximation formula, and the determination unit may determine a write strategy in which the jitter frequency of jitter occurrences is zero from the transformed first order approximation formula.

According to another aspect of the present invention, there is provided a method of recording data onto an optical disk, the method including: recording test data for each size of marks and spaces based on a plurality of write strategies; reproducing the recorded test data; measuring jitter values of the reproduced test data based on the plurality of write strategies; determining an optimal write strategy by using the measured jitter values; and recording the data onto the optical disk based on the determined write strategy.

The determining of the optimal write strategy by using the measured jitter value may include: constructing a jitter matrix for each size of the marks and the spaces by using the measured jitter values; and determining a write strategy in which the absolute value of a measured jitter value is minimized from the jitter matrix.

The plurality of write strategies may have various laser focusing time lengths.

In the constructing of the jitter matrix for each size of the marks and the spaces by using the measured jitter values, positive and negative matrices may be separately constructed by using the measured jitter values.

The determining of the write strategy in which the absolute value of the measured jitter value is minimized from the jitter matrix may include: obtaining a function of jitter values based on the write strategies from the positive and negative jitter matrices; and determining a write strategy in which a jitter value is zero from the function of jitter values based on the write strategies.

According to another aspect of the present invention, there is provided an apparatus for recording data onto an optical disk, the apparatus including: a recording and reading unit to record test data for each size of marks and spaces according to a plurality of write strategies, and to reproduce the recorded test data based on a plurality of write strategies; a control unit to measure jitter values of the reproduced test data and to determine a write strategy of an optical disk by using the measured jitter values; and a recording unit to record data onto the optical disk based on the determined write strategy.

The control unit may include: a measurement unit to measure jitter values of the reproduced test data based on the plurality of write strategies; a matrix construction unit to construct a jitter matrix for each size of the marks and the spaces by using the measured jitter values; and a determination unit to determine a write strategy in which an absolute value of a measured jitter value is minimized from the jitter matrix.

The plurality of write strategies may have various laser focusing time lengths.

The matrix construction unit may separately construct positive and negative matrices by using the measured jitter value.

The determination unit may obtain a function of jitter values based on the write strategies from the positive and negative jitter matrices and determine a write strategy in which a jitter value is zero from the function of jitter values.

The matrix construction unit may separately construct positive and negative matrices by using the measured jitter values, and the determination unit may obtain a function of jitter values based on the write strategies from the positive and negative jitter matrices and determine a write strategy in which a jitter value is zero from the function of jitter values.

According to another aspect of the present invention, there is provided a computer-readable recording medium having embodied thereon a computer program for executing a method of determining a write strategy, the method including: recording test data for each size of marks and spaces based on a plurality of write strategies; reproducing the recorded test data; measuring jitter values of the reproduced test data based on the plurality of write strategies; and determining an optimal write strategy by using the measured jitter values.

According to another aspect of the present invention, there is provided a computer-readable recording medium having embodied thereon a computer program for executing a method of recording data onto an optical disk, the method including: recording test data for each size of marks and spaces based on a plurality of write strategies; reproducing the recorded test data; measuring jitter values of the reproduced test data based on the plurality of write strategies; determining an optimal write strategy by using the measured jitter values; and recording the data onto the optical disk based on the determined write strategy.

According to still another aspect of the present invention, there is provided an apparatus for determining an optimal write strategy according to reproduced test data that is recorded as a plurality of marks and spaces having different sizes based on a plurality of different write strategies, the apparatus including: a measurement unit to measure jitter values of the reproduced test data for each of the plurality of different write strategies; a matrix construction unit to construct a jitter matrix for each size of the marks and the spaces by using the measured jitter values; and a determination unit to determine an optimal write strategy to be a write strategy for which an absolute value of a measured jitter value is minimized from the jitter matrix.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an apparatus for determining a write strategy according to an embodiment of the present invention;

FIGS. 2A through 2C are graphs illustrating a relation between an RF signal and a jitter;

FIGS. 3A and 3B are graphs illustrating a relation between an RF signal and a jitter;

FIG. 4 is a reference view illustrating a method of calculating a jitter value;

FIG. 5 is a block diagram illustrating a detailed structure of a determination unit shown in FIG. 1;

FIG. 6 is a table illustrating an example of a jitter matrix constructed with measured jitter values;

FIG. 7 is a reference view illustrating an example of a structure of a write strategy;

FIG. 8 is a graph of a jitter value and an occurrence frequency of a jitter versus a laser focusing time;

FIG. 9 is a graph of a difference between the frequency of occurrence of a positive jitter and the frequency of occurrence of a negative jitter;

FIG. 10 illustrates an example in which a difference between the frequency of occurrence of a positive jitter and the frequency of occurrence of a negative jitter is transformed into a first order approximated formula;

FIGS. 11A and 11B are reference views illustrating the frequency of occurrence of a jitter transformed through a determination of a write strategy;

FIG. 12 illustrates an example of a procedure of determining an optimal write strategy by changing a write strategy and recording data onto a test area based on the changed write strategy;

FIG. 13 is a flowchart illustrating a method of determining a write strategy according to an embodiment of the present invention; and

FIG. 14 is a flowchart illustrating a method of recording data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

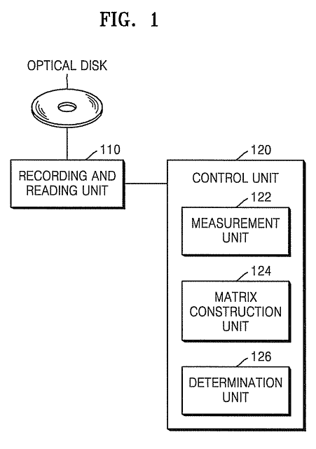

FIG. 1 is a block diagram illustrating an apparatus for determining a write strategy according to an embodiment of the present invention. Referring to FIG. 1, the apparatus for determining a write strategy according to the embodiment of the present invention includes a recording and reading unit 110 and a control unit 120. The control unit 120 includes a measurement unit 122, a matrix construction unit 124, and a determination unit 126.

The recording and reading unit 110 records test data onto a test area of an optical disk based on a plurality of write strategies. Then, the recording and reading unit 110 reproduces the recorded test data. Specifically, the test data is recorded onto the test area by applying a plurality of different write strategies. For example, the test data may be recorded by irradiating laser beams having different power magnitudes or by changing a laser focusing time. The test area may include a plurality of sectors. The test data may be recorded onto the sectors by applying different write strategies for each of the sectors. Furthermore, the test data may be recorded for each size of marks and spaces. That is, in a recording pattern of the test data recorded onto a sector, marks and spaces having various sizes T are represented, where T is the length of a clock pulse.

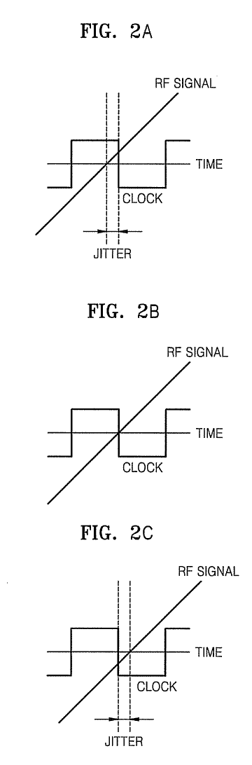

The control unit 120 determines an appropriate write strategy of the optical disk based on signal qualities of the reproduced test data that is recorded using a variety of write strategies. The control unit 120 includes the measurement unit 122, the matrix construction unit 124, and the determination unit 126. The measurement unit 122 measures a jitter value of the reproduced test data for each of the plurality of write strategies. Measurement of the jitter and the jitter value will be described later with reference to FIGS. 2 through 4.

The matrix construction unit 124 constructs a jitter matrix for each size of marks and spaces by using the measured jitter values. For example, in a Blu-ray Disc (BD), since the sizes of marks and spaces range from 2T to 9T, jitter matrices are constructed for each size of marks and spaces. The matrix construction unit 124 may, although not necessarily, separately construct positive and negative jitter matrices.

The determination unit 126 determines a write strategy in which the absolute value of the jitter measured from the jitter matrix is minimized. When the jitter is minimized, the signal quality is at a highest level. Accordingly, it is possible to secure a high signal quality by recording data with the write strategy in which the jitter is minimized.

FIGS. 2A through 2C are examples in which a jitter occurs between an RF signal in which an offset is removed and a falling edge of a system clock. In an ideal case (i.e., no jitter), an edge of the system clock is accurately matched with a zero-crossover of the RF signal as shown in FIG. 2B. However, in practice, the edge of the system clock is not accurately matched with the zero-crossover of the RF signal. That is, there is a temporal difference between the edge of the system clock and the zero-crossover of the RF signal. In a case where the edge of the clock precedes the zero-crossover of the RF signal, as illustrated in FIG. 2A, a difference occurs. Similarly, in a case where the edge of the clock proceeds the zero-crossover of the RF signal, as illustrated in FIG. 2C, a difference also occurs. The difference indicates a jitter.

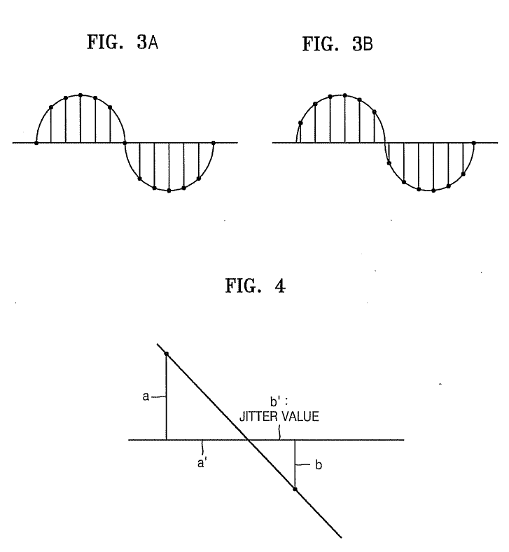

The jitter value is the difference between the RF signal and the system clock, and is used to estimate the quality of the RF signal. In an ideal case, since the zero-crossover of the RF signal is accurately located at the edge of the system clock, the jitter value is at a minimum. According to an aspect of the present invention, when the zero-crossover of the RF signal is located at the edge of the system clock, no measurement is taken of the jitter value. However, aspects of the present invention are not limited thereto, and according to other aspects, the jitter value may be measured even if the jitter value is zero. When the zero-crossover of the RF signal is not accurately located at the edge of the system clock if, for example, noise or an erroneous situation occurs in the RF signal, the jitter value is measured. FIG. 3A illustrates a signal when there is no jitter. FIG. 3B illustrates a signal when a jitter occurs due to an asynchronous situation.

FIG. 4 is a reference view illustrating a method of calculating a jitter value. When an analog signal is sampled, obtainable sample values are a and b. Since the system clock is constant, a value of a′+b′ is constant as the system clock. Since a value of b′ is a temporal difference between the system clock and an input signal, the value of b′ is a jitter value. The signal is assumed to be linear near the zero-crossover, and thus, the following equation is satisfied:

a:a′=b:b′

a′+b′=system clock

Here, since a, b, and the system clock are known, the following equation is obtained by using the above equations:

b′=b*system clock/(a+b)

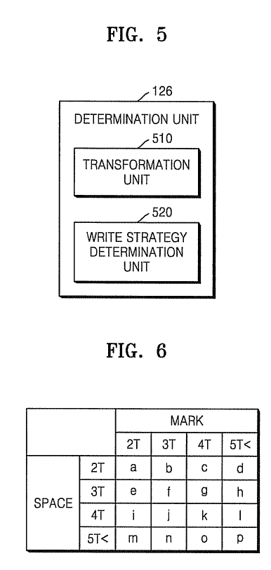

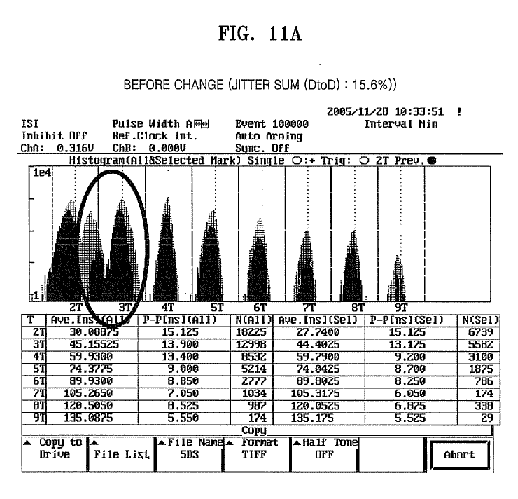

FIG. 5 is a block diagram illustrating a detailed structure of the determination unit 126 shown in FIG. 1. The determination unit 126, according to an embodiment of the present invention, includes a transformation unit 510 and a write strategy determination unit 520. The matrix construction unit 124 (illustrated in FIG. 1) may separately construct positive and negative matrices. The transformation unit 510 obtains a function of jitter or function of jitter frequency based on the write strategy by using the constructed jitter matrices. Then, the transformation unit 510 transforms the obtained function into a first order approximation formula. The function may be transformed into a first order approximation formula by connecting a positive jitter value to a negative jitter value, which have the same size of marks and the same size of spaces in the graph of the function of jitter. The transformation will be described later with reference to FIG. 10. The obtained function is transformed into the first order approximation formula because it is easier to find a point at which the jitter value is zero when the function has been transformed into the first order approximation formula.

The write strategy determination unit 520 determines an optimal write strategy from the first order approximation formula transformed by the transformation unit 510. When the first order approximation formula is a function of jitter, the write strategy determination unit determines a write strategy in which the function of jitter is zero. When the first order approximation formula is a function of jitter frequency, the determination unit determines a write strategy in which the function of jitter frequency is zero.

FIG. 6 is a table illustrating a jitter matrix constructed with measured jitter values. Jitter matrices are divided into positive and negative jitter matrices. Jitter values or jitter frequencies for each size of marks and spaces are recorded onto the jitter matrix. For example, when the size of marks is 2T and when the size of spaces is 2T, a jitter having a value of “a” occurs, or a jitter having a frequency of “a” occurs, depending on whether jitter values or jitter frequencies are recorded onto the jitter matrix. When a matrix is constructed based on the current mark, it is necessary to distinguish whether the space is a space before the current mark or a space after the current mark. That is, it is necessary to distinguish whether the jitter is a jitter in the case where a space follows a mark or a jitter in the case where the mark follows the space.

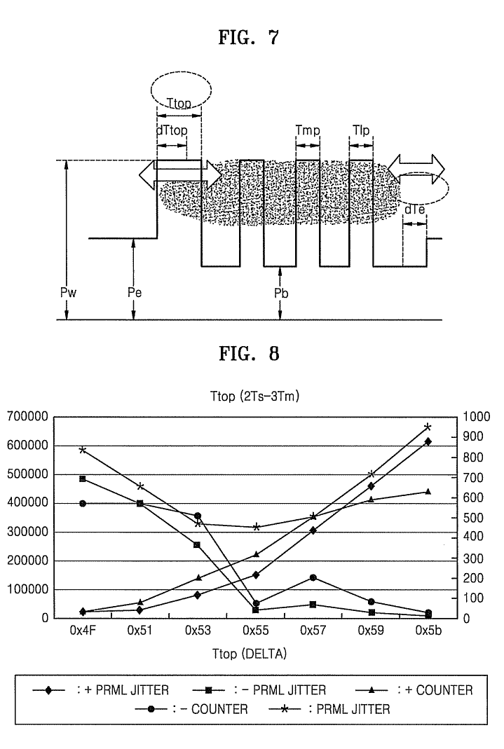

FIG. 7 is a reference view illustrating an example of a structure of a write strategy. Referring to FIG. 7, a shaded region is a mark, and a non-shaded region is a space. When test data is recorded onto a test area, a line indicates a magnitude of a laser that is focused on the mark. Pw indicates a maximum magnitude of the laser. Ttop, Tmp, and Tlp indicate laser focusing times. In FIG. 7, the laser is focused for 4T and a jitter of dTe occurs. Since the directionality of the jitter is the (−) direction, when the test data is recorded by using a write strategy that is controlled so that a power corresponding to the magnitude of the laser or the laser focusing time increases, it is possible to reduce the jitter value. As described with reference to FIG. 2, the directionality of the jitter value is known according to where the zero-crossover of a signal is located with respect to the clock edge.

FIG. 8 is a graph of a jitter value and a jitter frequency versus a laser focusing time. As the laser focusing time increases, the magnitude of the positive jitter value decreases and the jitter frequency decreases. In addition, as the laser focusing time increases, the magnitude of the negative jitter value increases and the jitter frequency increases. Referring to FIG. 8, the jitter value is measured when the size of marks is 2T and when the size of spaces is 2T. The jitter frequency is calculated starting from the space with the size of 2T and the mark with the size of 2T. Accordingly, it is possible to know how many times jitters occur for each T. A jitter matrix can be constructed based on T.

As the laser focusing time, Ttop, of the mark changes, the positive or negative jitter value and the jitter frequency changes. When the total jitter is minimized (i.e., when the mark is optimally recorded), jitter values having opposite signs and jitter frequencies having opposite signs respectively cross with each other. Accordingly, PLL is matched with an edge of a recorded signal when the jitter is minimized. For example, when a write strategy is controlled so that the edge of the signal is shifted toward the (+) side so as to adjust the edge of the signal shifted toward the (−) side, there exists a section located immediately before the edge is shifted toward the (+) side. In this section, the jitter is minimized. In FIG. 8, when Ttop is near 0×55, the total jitter is minimized and the laser focusing time is the optimal write strategy.

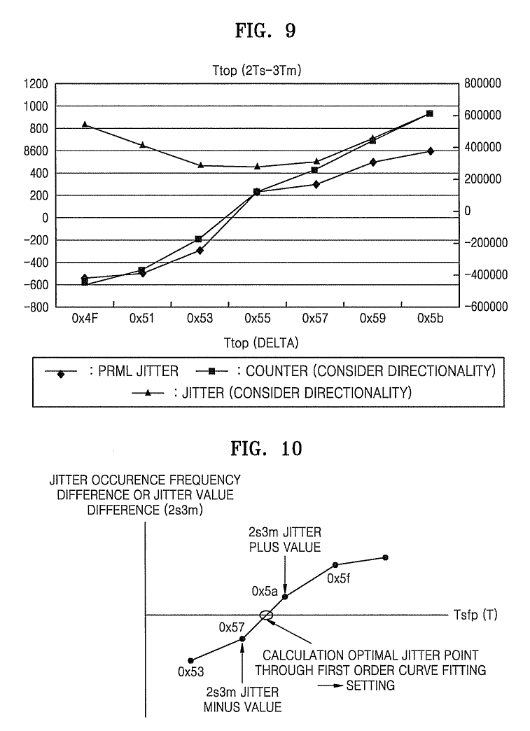

FIG. 9 is a graph showing a difference between the frequency of occurrence of a positive jitter and the frequency of occurrence of a negative jitter. In FIG. 9, a plot obtained by subtracting a negative function of jitter from a positive function of jitter and a plot obtained by subtracting a negative jitter frequency from a positive jitter frequency are shown. The laser focusing time at a location where the jitter value difference and the jitter frequency difference are near zero is an optimal write strategy.

FIG. 10 illustrates an example in which a difference between the frequency of occurrence of a positive jitter and the frequency of occurrence of a negative jitter is transformed into a first order approximated formula. As shown in FIG. 10, when the jitter frequency difference or jitter value difference obtained in FIG. 9 is fitted to a first order polynomial, it is possible to easily determine where the jitter frequency difference or jitter value difference is zero (or near zero) in a first order linear relation. The jitter frequency difference or jitter value difference can be fitted to the first order polynomial by connecting a negative jitter value to a positive jitter value, which have the same size of marks and the same size of spaces, or by linearly connecting a negative jitter frequency to a positive jitter frequency, which have the same size of marks and the same size of spaces, on the graph of the jitter frequency difference function. In the first order linear relation, when a y-axis component is zero, the corresponding laser focusing time (the x-axis in FIG. 10) is to be used in an optimal write strategy. When data is recorded with the optimal write strategy obtained from the first order approximation formula, it is possible to improve data reproduction quality.

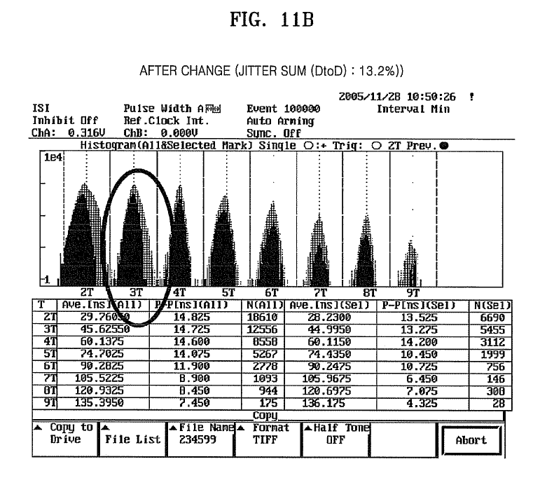

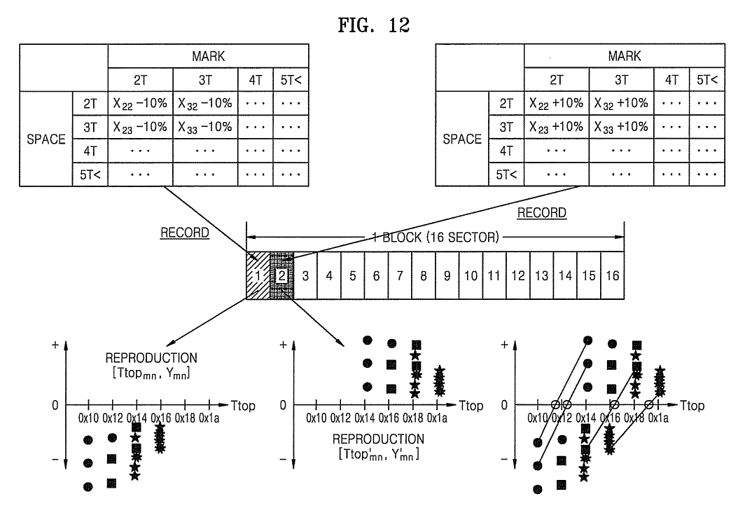

FIGS. 11A and 11B are reference views illustrating the frequency of occurrence of a jitter changed due to a determination of a write strategy. FIG. 11A is a histogram of a jitter frequency based on T when recording data without determining an optimal write strategy. Referring to FIG. 11A, a jitter value with respect to 3T is zero at a central dotted line, and the frequency of the positive jitter value is not balanced with the frequency of the negative jitter value. At this time, a jitter deviation is 15.6%.

FIG. 11B is a histogram of a jitter frequency based on T when recording data after determining an optimal write strategy by using a write strategy determination apparatus according to an embodiment of the present invention. Referring to FIG. 11B, when a jitter with respect to 3T is compared with a jitter in FIG. 11A, a frequency of a positive jitter value is balanced with a frequency of a negative jitter value with respect to zero. In addition, the reproduction quality is also improved with respect to other values of T such as 2T, 5T, and the like. The jitter deviation is reduced to 13.2% after changing a write strategy.

FIG. 12 illustrates an example of a procedure of determining an optimal write strategy by changing a write strategy and recording data using the changed write strategy in a test area. Test data is recorded onto the test area using different write strategies. Unlike the jitter matrix of FIG. 6, the matrix on the left side of FIG. 12 indicates a recording pattern obtained by applying a write strategy of −10% to marks and spaces, and the matrix on the right side of FIG. 12 indicates a recording pattern obtained by applying a write strategy of +10% to marks and spaces.

The test area shown in FIG. 12 is a block constructed with 16 sectors. For example, test data is recorded onto an N-th sector based on −10% write strategy and recorded onto a (N+1)-th sector based on +10% write strategy. The test data is recorded onto each sector while storing the test data in an array.

Graphs located in a lower part of FIG. 12 illustrate a jitter value obtained when reproducing test data recorded onto the test area. The first graph illustrates a distribution of negative jitter values. The second graph illustrates a distribution of positive jitter values. The third graph illustrates a procedure of finding a suitable write strategy in order to balance the positive jitter values with the negative jitter values. For example, a laser focusing time Ttop (the x-axis) corresponding to an intersection point between the y-axis and a straight line which connects a negative jitter value of 2T2S with a positive jitter value of 2T2S is determined to be an optimal write strategy.

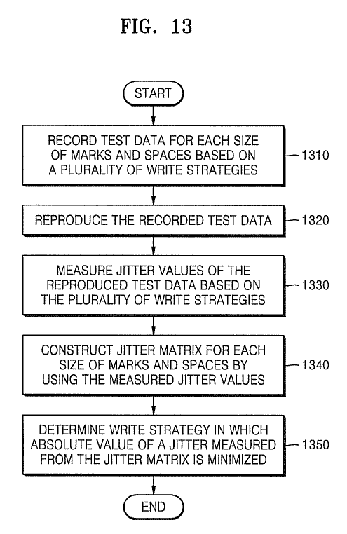

FIG. 13 is a flowchart illustrating a method of determining a write strategy according to an embodiment of the present invention. In operation 1310, test data is recorded, with a plurality of write strategies, onto a test area of an optical disk. The test data is recorded onto the test area by applying a plurality of different write strategies (for example, by using various powers of laser irradiation or by changing laser focusing time). Then, in operation S1320, the test data recorded onto the test area (operation S1310) is reproduced.

In operation 1330, a jitter value of the reproduced test data for each of the plurality of write strategies is measured. In operation 1340, a jitter matrix is constructed for each size of marks and spaces by using the measured jitter values. At this time, positive and negative jitter matrices are separately constructed.

In operation 1350, a write strategy is determined in which the absolute value of the jitter measured from the jitter matrix is minimized. Specifically, a function of jitter or a function of jitter frequency based on the write strategy is obtained first by using the constructed jitter matrix. The obtained function is then transformed into a first order approximation formula by, for example, forming straight lines connecting negative jitter values with positive jitter values. Each positive-negative jitter value pair has the same size of mark and the same size of spaces in the graph of the function of jitter. Next, an optimal write strategy is determined from the first order approximation formula. When the first order approximation formula is a function of jitter, the write strategy determination unit determines a write strategy in which the function of jitter is zero. When the first order approximation formula is a function of jitter frequency, the determination unit determines a write strategy in which the function of jitter frequency is zero. A write strategy indicates a magnitude of power of a laser for recording data or a laser focusing time. Accordingly, when a jitter value is biased towards the positive side, it is possible to shift the jitter value to the negative side by reducing the magnitude of the power or laser focusing time.

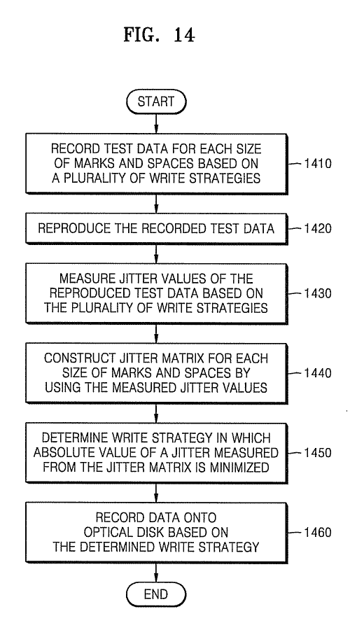

FIG. 14 is a flowchart illustrating a method of recording data according to an embodiment of the present invention. In operation 1410, test data is recorded, with a plurality of write strategies, onto a test area. For example, the plurality of write strategies includes using various magnitudes of laser power and/or various laser focusing times.

Then, in operation 1420, the test data recorded onto the test area is reproduced. In operation 1430, a jitter value of the reproduced test data for each of the plurality of write strategies is measured. In operation 1440, a jitter matrix is constructed for each size of marks and spaces by using the jitter values. At this time, positive and negative jitter matrices are separately constructed.

In operation 1450, a write strategy is determined in which the absolute value of the measured jitter is minimized. An optimal write strategy is determined in order to balance a positive jitter value with a negative jitter value or in order to balance a positive jitter frequency with a negative jitter frequency. Specifically, a function of jitter or a function of jitter frequency based on the write strategy is obtained first by using the constructed jitter matrix. The obtained function is then transformed into a first order approximation formula by, for example, forming straight lines connecting negative jitter values with positive jitter values. Each positive-negative jitter value pair has the same size of mark and the same size of spaces in the graph of the function of jitter. Next, an optimal write strategy is determined from the first order approximation formula. When the first order approximation formula is a function of jitter, the write strategy determination unit determines a write strategy in which the function of jitter is zero. When the first order approximation formula is a function of jitter frequency, the determination unit determines a write strategy in which the function of jitter frequency is zero. A write strategy indicates a magnitude of power of a laser for recording data or a laser focusing time. Accordingly, when a jitter value is biased towards the positive side, it is possible to shift the jitter value to the negative side by reducing the magnitude of the power or laser focusing time.

Next, in operation 1460, data desired to be recorded is recorded onto an optical disk by applying the optimal write strategy determined in operation 1450. It is possible to improve data reproduction quality by applying the optimal write strategy.

As described above, according to aspects of the present invention, it is possible to improve data recording and reproducing quality by determining an optimal write strategy based on a disk or recording and reproducing apparatus.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of determining an optimal write strategy, the method comprising:
recording test data with a plurality of different write strategies;
reproducing the recorded test data;
measuring jitter values of the reproduced test data for each of the plurality of different write strategies; and
determining an optimal write strategy according to the measured jitter values.

2. The method as claimed in claim 1, wherein the recording of the test data comprises:
recording the test data as a plurality of marks and spaces having different sizes based on the plurality of different write strategies.

3. The method as claimed in claim 2, wherein the determining of the optimal write strategy according to the measured jitter value comprises:
constructing a jitter matrix for each size of the marks and the spaces by using the measured jitter values; and
determining the optimal write strategy to be a write strategy for which an absolute value of a measured jitter value is minimized from the jitter matrix.

4. The method as claimed in claim 1, wherein the plurality of different write strategies comprises recording the test data with a first laser focusing time length and recording the test data with a second laser focusing time length.

5. The method as claimed in claim 3, wherein the constructing of the jitter matrix for each size of the marks and the spaces comprises:
constructing a positive matrix and a negative matrix for each size of the marks and the spaces by using the measured jitter values.

6. The method as claimed in claim 5, wherein the determining of the optimal write strategy comprises:
obtaining a function of jitter values based on the write strategies from the positive matrix and the negative matrix for each size of the marks and the spaces; and
determining the optimal write strategy to be a write strategy for which a jitter value is zero from the function of jitter values based on the write strategies.

7. The method as claimed in claim 6, wherein the determining of the optimal write strategy to be the write strategy for which the jitter value is zero from the function of jitter values comprises:
transforming the function of jitter values based on the write strategies into a first order approximation formula; and
determining the optimal write strategy to be the write strategy for which the jitter value is zero from the transformed first order approximation formula.

8. The method as claimed in claim 3, wherein the constructing of the jitter matrix for each size of the marks and the spaces comprises:
constructing a positive matrix and a negative matrix for each size of the marks and the spaces including information on frequency of jitter occurrences for each size of the marks and the spaces by using the measured jitter values.

9. The method as claimed in claim 8, wherein the determining of the optimal write strategy comprises:
obtaining a function of frequency of jitter occurrences based on the write strategies from the positive matrix and the negative matrix for each size of the marks and the spaces; and
determining the optimal write strategy to be a write strategy for which a frequency of jitter occurrences is zero from the function of frequency of jitter occurrences based on the write strategies.

10. The method as claimed in claim 9, wherein the determining of the optimal write strategy to be the write strategy for which the frequency of jitter occurrence is zero from the function of frequency of jitter occurrences comprises:
transforming the function of frequency of jitter occurrences based on the write strategies into a first order approximation formula; and
determining the optimal write strategy to be the write strategy for which the frequency of jitter occurrences is zero from the transformed first order approximation formula.

11. The method as claimed in claim 1, wherein the plurality of different write strategies comprises recording the test data with a first magnitude of laser power and recording the test data with a second magnitude of laser power.

12. The method as claimed in claim 1, wherein the recording of the test data comprises:
recording the test data with a first writing strategy in a first sector of a test area; and
recording the test data with a second writing strategy in a second sector of the test area.

13. An apparatus for determining a write strategy, the apparatus comprising:
a recording and reading unit to record test data with a plurality of different write strategies, and to reproduce the recorded test data; and
a control unit to measures jitter values of the reproduced test data for each of the plurality of different write strategies, and to determine an optimal write strategy of an optical disk according to the measured jitter values.

14. The apparatus as claimed in claim 13, wherein the recording and reading unit records the test data as a plurality of marks and spaces having different sizes based on the plurality of different write strategies.

15. The apparatus as claimed in claim 14, wherein the control unit comprises:
a measurement unit to measure the jitter values of the reproduced test data for each of the plurality of different write strategies;
a matrix construction unit to construct a jitter matrix for each size of the marks and the spaces by using the measured jitter values; and
a determination unit to determine the optimal write strategy to be a write strategy for which an absolute value of a measured jitter value is minimized from the jitter matrix.

16. The apparatus as claimed in claim 13, wherein the plurality of different write strategies comprises recording the test data with a first laser focusing time length and recording the test data with a second laser focusing time length.

17. The apparatus as claimed in claim 15, wherein the matrix construction unit constructs a positive matrix and a negative matrix for each size of the marks and the spaces by using the measured jitter values.

18. The apparatus as claimed in claim 17, wherein the determination unit obtains a function of jitter values based on the write strategies from the positive matrix and the negative matrix for each size of the marks and the spaces, and determines the optimal write strategy to be a write strategy for which a jitter value is zero from the function of jitter values.

19. The apparatus as claimed in claim 18, wherein the determination unit further comprises:
a transformation unit to transform the function of jitter values based on the write strategies into a first order approximation formula, such that the determination unit determines the optimal write strategy to be the write strategy for which the jitter value is zero from the transformed first order approximation formula.

20. The apparatus as claimed in claim 15, wherein the matrix construction unit constructs a positive matrix and a negative matrix for each size of the marks and the spaces including information on frequency of jitter occurrences for each size of the marks and the spaces by using the measured jitter values.

21. The apparatus as claimed in claim 20, wherein the determination unit obtains a function of frequency of jitter occurrences based on the write strategies from the positive matrix and the negative matrix for each size of the marks and the spaces, and determines the optimal write strategy to be a write strategy for which a frequency of jitter occurrences is zero from the function of frequency of jitter occurrences based on the write strategies.

22. The apparatus as claimed in claim 21, wherein the determination unit further comprises:
a transformation unit to transform the function of frequency of jitter occurrences based on the write strategies into a first order approximation formula, such that the determination unit determines the optimal write strategy to be the write strategy for which the frequency of jitter occurrences is zero from the transformed first order approximation formula.

23. The apparatus as claimed in claim 13, wherein the plurality of different write strategies comprises recording the test data with a first magnitude of laser power and recording the test data with a second magnitude of laser power.

24. The apparatus as claimed in claim 13, wherein the recording and reading unit records the test data with a first writing strategy in a first sector of a test area, and records the test data with a second writing strategy in a second sector of the test area.

25. A method of recording data onto an optical disk, the method comprising:
recording test data with a plurality of different write strategies;
reproducing the recorded test data;
measuring jitter values of the reproduced test data for each of the plurality of different write strategies;
determining an optimal write strategy according to the measured jitter values; and
recording the data onto the optical disk with the determined optimal write strategy.

26. The method as claimed in claim 25, wherein the recording of the test data comprises:
recording the test data as a plurality of marks and spaces having different sizes based on the plurality of different writes strategies.

27. The method as claimed in claim 26, wherein the determining of the optimal write strategy according to the measured jitter value comprises:
constructing a jitter matrix for each size of the marks and the spaces by using the measured jitter values; and
determining the optimal write strategy to be a write strategy for which an absolute value of a measured jitter value is minimized from the jitter matrix.

28. The method as claimed in claim 27, wherein the constructing of the jitter matrix for each size of the marks and the spaces comprises:
constructing a positive matrix and a negative matrix for each size of the marks and the spaces by using the measured jitter values.

29. An apparatus for recording data onto an optical disk, the apparatus comprising:
a recording and reading unit to record test data with a plurality of different write strategies, and to reproduce the recorded test data;
a control unit to measure jitter values of the reproduced test data for each of the plurality of write strategies, and to determine an optimal write strategy of an optical disk according to the measured jitter values; and
a recording unit to record data onto the optical disk with the determined optimal write strategy.

30. The apparatus as claimed in claim 29, wherein the recording and reading unit records the test data as a plurality of marks and spaces having different sizes based on the plurality of different write strategies.

31. The apparatus as claimed in claim 30, wherein the control unit comprises:
a measurement unit to measure the jitter values of the reproduced test data for each of the plurality of different write strategies;
a matrix construction unit to construct a jitter matrix for each size of the marks and the spaces by using the measured jitter values; and
a determination unit to determine the optimal write strategy to be a write strategy for which an absolute value of a measured jitter value is minimized from the jitter matrix.

32. The apparatus as claimed in claim 31, wherein:
the matrix construction unit constructs a positive matrix and a negative matrix for each size of the marks and the spaces by using the measured jitter values; and
the determination unit obtains a function of jitter values based on the write strategies from the positive matrix and the negative matrix for each size of the marks and the spaces, and determines the optimal write strategy to be a write strategy for which a jitter value is zero from the function of jitter values.

33. A computer-readable recording medium encoded with the method of claim 1 and implemented by a computer.

34. A computer-readable recording medium encoded with the method of claim 25 and implemented by a computer.
